(19) United States
(12) Patent Application Publication
(10) Pub. No.: US 2007/0229765 A1
(43) Pub. Date: Oct. 4, 2007

(54) Projection system and method

(75) Inventor: Halvard Buset, Oslo (NO)

Correspondence Address: ALLEMAN HALL MCCOY RUSSELL & TUTTLE LLP, 806 SW BROADWAY, SUITE 600, PORTLAND, OR, 97205-3335, US

(73) Assignee: InFocus Corporation

(21) Appl. No.: 11/396,042

(22) Filed: Mar. 30, 2006

(51) Int. Cl. G03B 21/14

(52) U.S. Cl. 353/20

(57) ABSTRACT

A light engine. The light engine can include an illumination source that produces light for projecting a still or motion video image. The light engine also can include a condenser configured to receive unpolarized light from the illumination source and output a focused beam of unpolarized light. A polarizing assembly arranged downstream of the condenser can be configured to receive the focused beam of unpolarized light and output substantially polarized light. The polarized light can be directed to a transmissive liquid crystal display panel that receives the substantially polarized light and transmits a video image.

### BACKGROUND

Projection devices can be used to present still and/or motion video images to one or more viewers. Projection devices can be variously configured to suit a variety of different applications. For example, some projection devices are designed to provide a very bright, high-resolution image with excellent contrast and color accuracy. Some projection devices are designed to be relatively small, lightweight devices that can easily be transported. Depending on an intended use, projection devices can be configured with optical designs that are engineered to provide a desired combination of cost, image quality, device portability, energy efficiency, device life, manufacturing simplicity, and/or other factors.

### SUMMARY

The inventor herein has recognized that the optical designs of known projection devices are not as cost effective as desired and/or do not provide desired device life. These and other issues can be addressed by a projection device that includes a polarizing assembly positioned downstream relative a main condenser and/or a projection device that does not include an input polarizer for each liquid crystal display panel.

### BRIEF DESCRIPTION OF THE DRAWINGS

FIG. 1 schematically shows a liquid crystal display (LCD) optical engine including a polarizing beam splitter upstream of a condenser and separate input polarizers between the polarizing beam splitter and each LCD panel.

FIG. 2 schematically shows one color channel of an optical engine that includes a polarizing assembly downstream of a condenser and which does not include an input polarizer between the polarizing beam splitter and the liquid crystal display panel.

FIG. 3 schematically shows an exemplary polarizing assembly that includes a wire grid polarizer, a mirror, and a half-wave plate.

### WRITTEN DESCRIPTION

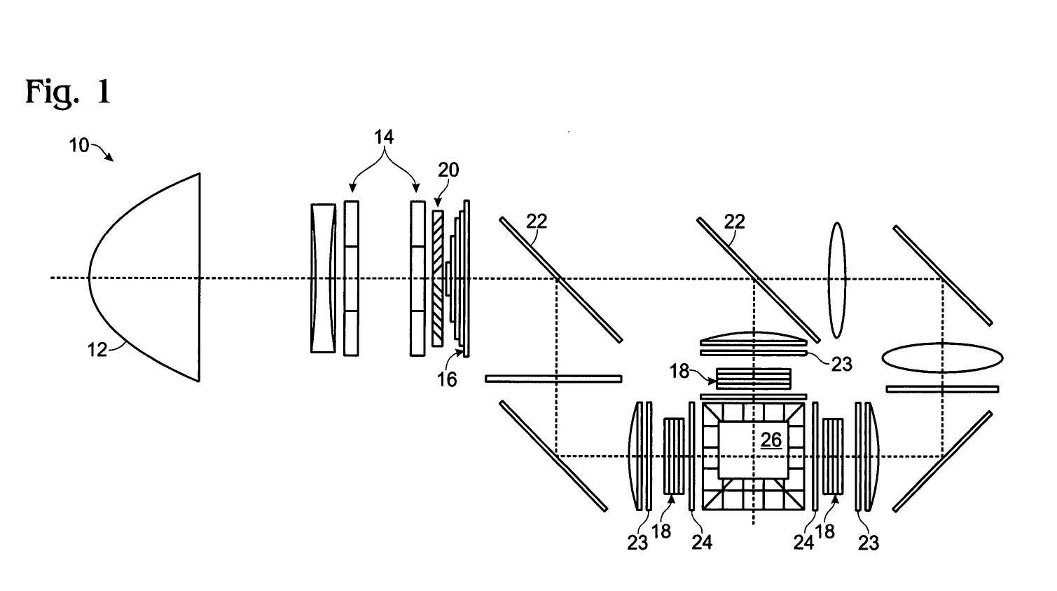

FIG. 1 shows an optical engine 10 that can be used in a variety of differently configured projection devices. Optical engine 10 includes a light source 12 in the form of a high-intensity lamp module. A variety of different types of light sources can be used. As a nonlimiting example, the light source can include a halogen lamp, arc lamp, metal halide lamp, UHP (Ultra High Performance) lamp, UHE (Ultra High Efficiency) lamp, and/or other suitable light emitting device. The light from the light source may be unpolarized. The light source can include one or more lenses.

Light from light source 12 can be passed to one or more integrators 14, which can tailor the light so that it provides substantially even illumination downstream of the integrators. The light may be passed from the integrator(s) to a condenser 16 (e.g., main condenser lens), which can focus the light onto one or more liquid crystal display (LCD) panels 18.

A variety of differently configured LCD panels can be used in a projection device. As a nonlimiting example, FIG. 1 shows a transmissive LCD panel. A transmissive LCD is illuminated from the back by a backlight (e.g., light source 12) and is viewed from the opposite side of the backlight. The individual pixels of the transmissive LCD panel can change polarization, thus causing more or less light absorption in the analyzer. This modulates the light and creates the image that is projected to a viewing screen. In contrast, reflective LCD technologies, such as Liquid Crystal on Silicon (LCoS), form images with light that is reflected by the LCD panel, not transmitted through the LCD panel. In LCoS, liquid crystals are applied directly to the surface of a silicon chip coated with an aluminized layer making it highly reflective. Light can then be selectively passed to the projection lens depending on the polarization state of the LCoS. This modulates the light and creates the image.

As shown in FIG. 1, LCD optical engines may contain three separate transmissive LCD panels, one each for the red, green, and blue components of a video signal. As light passes through the LCD panels, the polarization of individual pixels of the LCD panels can be changed to modulate the light. This modulates the light and produces the image that is projected onto the screen.

LCD panels may be designed to operate on polarized light. In many arrangements, light that comes from a light source, such as light source 12, will not be polarized. Furthermore, integrators and/or a condenser may pass the unpolarized light without polarizing it. In such situations, one or more polarizers can be positioned upstream of the LCD panels so that light that reaches the LCD panels is properly polarized. Polarizing beam splitter (PBS) 20 is a nonlimiting example of a polarizer.

The optical engine can include an arrangement for separating white light from the light source into a plurality of beams having different wave lengths. For example, the optical engine can include a set of dichroic filters 22, which can be used to direct separated red light, blue light, and green light to the three different LCD panels. Dichroic filters and/or other optical components can decrease polarization and/or the upstream polarizer may not completely polarize the light from the light source. Therefore, an input, or clean-up, polarizer 23 can be used upstream of each LCD panel to condition the light for that LCD panel.

An analyzer 24 can be positioned downstream of each LCD panel. The analyzer can be configured to absorb light which is not parallel to its transmission axis. The light from each color channel can then be combined by a combiner 26 and directed to a projection screen via suitable projection optics.

Optical engine 10 includes a total of three input polarizers 23, one each for the red, green, and blue LCD panels. Known input polarizers can be expensive and can require cooling in order to work properly and/or to maintain an acceptable operating life. The PBS can also be relatively expensive and/or require cooling. Image quality and/or other factors may warrant the cost and/or other issues that are associated with optical engine 10 for some applications. However, for some applications, a less expensive, smaller, cooler running, and/or longer lasting optical engine may be appropriate.

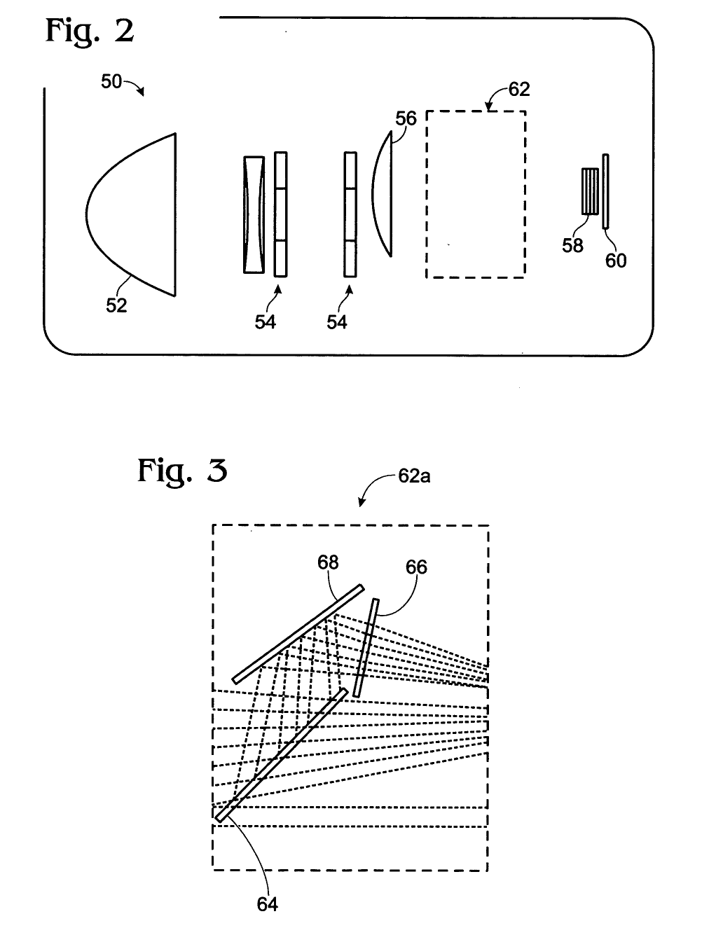

FIG. 2 schematically shows one color channel of an optical engine 50 that is designed to address at least some of the above described issues. It should be understood that two or more color channels, such as separate red, green, and blue color channels, can be used in an optical engine, and the illustrated color channel is schematically shown independent of other color channels for the sake of simplicity. The illustrated color channel of optical engine 50 includes a light source 52 (with lens 52a), integrators 54, a condenser 56, an LCD panel 58, and an analyzer 60, similar to the arrangement described above with reference to optical engine 10. However, unlike optical engine 10, optical engine 50 does not include a PBS upstream of the condenser, nor an input polarizer upstream of each LCD panel. Instead, optical engine 50 includes a polarizing assembly 62 (schematically illustrated) downstream of condenser 56. Furthermore, for the illustrated color channel, optical engine 50 does not include any input polarizers downstream of polarizing assembly 62.

Such an arrangement can eliminate several expensive components in a three color channel optical engine, including a PBS, at least two input polarizers, and at least two field lenses. Such an arrangement also can eliminate at least three potential durability problems, namely the PBS and at least two input polarizers. Furthermore, removal of the PBS allows for a reduction in the size of the integrators, which can result in further cost savings.

In some embodiments, clean-up polarizers can be used. Clean-up polarizers may allow home cinema projectors to be designed using engines from business presentation projectors. Furthermore, a system as described herein may result in relatively improved polarization, and thus can increase the operating lifetime of projectors with clean-up polarizers.

A nonlimiting example of a polarizing assembly 62 is schematically shown in FIG. 3. In particular, FIG. 3 shows a polarizing assembly 62a that includes a wire grid polarizer 64 and a half-wave plate 66. The wire grid polarizer can be configured to pass light of one polarization and to reflect light of the other polarization. The half-wave plate can be configured to rotate the polarization of the reflected light so that substantially all light downstream of the polarizing assembly has the same polarization. For example, the wire grid polarizer may pass light with 0° relative polarization and reflect light with 90° relative polarization, and the half-wave plate may be positioned to rotate the 90° relative polarization of the reflected light to 0° relative polarization so that all light has the same 0° relative polarization. The polarizing assembly may also include one or more mirrors 68, which can be used to direct passed light and/or reflected light. Mirrors that do not affect polarization, such as metal mirrors, can be used. In some embodiments, a dielectric mirror can be used.

A variety of different wire grid polarizers can be used without departing from the scope of this disclosure. Nonlimiting examples of wire grid polarizers are disclosed in U.S. Pat. Nos. 5,986,730; 6,081,376; 6,108,131; 6,122,103; 6,208,463; 6,234,634; 6,243,199; 6,288,840; 6,348,995; 6,447,120; 6,452,724; and 6,876,784; the contents of which are incorporated by reference. For example, U.S. Pat. No. 6,447,120 discloses a wire grid polarizer that is used in a projection system. However, unlike the projection system shown in FIG. 2, the projection system of U.S. Pat. No. 6,447,120 uses a reflective LCD panel, not a transmissive LCD panel. Conversion efficiency may be improved by using transmissive LCD panels.

The wire grid polarizing assembly shown in FIG. 3 is a nonlimiting example of a polarizing assembly that can be used downstream of a condenser lens and/or to allow designs that do not require input/clean-up polarizers upstream of each LCD panel.

By placing the polarizing assembly downstream of the condenser, brightness uniformity, contrast, and or other projection characteristics may be affected. However, such an arrangement may lower cost, provide longer device life, allow for smaller device designs, allow for quieter device designs, and/or provide other advantages. Accordingly, such an arrangement may be advantageously used for many applications.

Various aspects of this disclosure are described using terms commonly employed by those skilled in the art to convey the substance of their work to others skilled in the art. However, it should be apparent to those skilled in the art that alternate embodiments may be practiced with only some of the described aspects. For purposes of explanation, specific materials and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

The phrase “in some embodiments” may be used repeatedly. The phrase does not necessarily refer to the same embodiment; however, it may. The terms “comprising,” “having,” and “including” are synonymous, unless the context dictates otherwise.

1. A light engine, comprising:
an illumination source;
a condenser configured to receive unpolarized light from the illumination source and output a focused beam of unpolarized light;
a polarizing assembly configured to receive the focused beam of unpolarized light and output substantially polarized light; and
a transmissive liquid crystal display panel configured to receive the substantially polarized light and transmit a video image.

2. The light engine of claim 1, where the polarizing assembly includes a wire grid polarizer.

3. The light engine of claim 1, where the polarizing assembly comprises:
a polarizer configured to reflect light of a first polarization and pass light of a second polarization,
a mirror configured to reflect the light of the first polarization reflected from the polarizer, and
a half-wave plate configured to change to the second polarization the polarization of the light reflected from the mirror.

4. The light engine of claim 3, where the polarizer is a wire grid polarizer.

5. The light engine of claim 3, where the mirror is a metal mirror.

6. The light engine of claim 3, where the mirror is a dielectric mirror.

7. The light engine of claim 3, where the mirror and the half-wave plate are arranged to combine the reflected light with the light that passes through the polarizer.

8. The light engine of claim 1, further comprising one or more integrators optically intermediate the illumination source and the condenser and configured to receive light from the illumination source and output substantially homogeneous, unpolarized light to the condenser.

9. The light engine of claim 8, where at least one of the one or more integrators is a fly's eye lens.

10. The light engine of claim 1, where light from the polarizing assembly is suitably polarized for delivery to the transmissive liquid crystal display panel without further polarization.

11. The light engine of claim 1, where light from the polarizing assembly is suitably polarized for delivery to a liquid crystal display panel without further polarization by an input polarizer positioned intermediate the polarizing assembly and the transmissive liquid crystal display panel.

12. A light engine, comprising:
an illumination source;
a condenser configured to receive unpolarized light from the illumination source and output a focused beam of unpolarized light;
a polarizing assembly configured to receive the focused beam of unpolarized light and output substantially polarized light; and
a light modulator configured to receive the substantially polarized light and output a video image.

13. A projector, comprising:
an illumination source;
a condenser configured to receive unpolarized light from the illumination source and output a focused beam of unpolarized light;
a polarizing assembly configured to receive the focused beam of unpolarized light and output substantially polarized light;
a color separating assembly configured to separate the substantially polarized light into separate bands of substantially polarized red light, green light, and blue light;
a first transmissive liquid crystal display panel configured to modulate the substantially polarized red light;
a second transmissive liquid crystal display panel configured to modulate the substantially polarized green light;
a third transmissive liquid crystal display panel configured to modulate the substantially polarized blue light;
a combiner configured to align the modulated red light, green light, and blue light; and
a projection lens configured to project the modulated and aligned red light, green light, and blue light.

14. The projector of claim 13, where the polarizing assembly comprises:
a polarizer configured to reflect light of a first polarization and pass light of a second polarization,
a mirror configured to reflect the light of the first polarization reflected from the polarizer, and
a half-wave plate configured to change to the second polarization the polarization of the light reflected from the mirror.

15. The projector of claim 14, where the polarizer is a wire grid polarizer.

16. The projector of claim 14, where the mirror is a metal mirror.

17. The projector of claim 14, where the mirror is a dielectric mirror.

18. The projector of claim 14, where the mirror and the half-wave plate are arranged to combine the reflected light with the light that passes through the polarizer.

19. The projector of claim 13, where light from the polarizing assembly is suitably polarized for delivery to a liquid crystal display panel without further polarization.

20. A polarizing assembly, comprising:
a polarizer configured to reflect light of a first polarization and pass light of a second polarization;
a mirror configured to reflect the light of the first polarization reflected from the polarizer; and
a half-wave plate configured to change to the second polarization the polarization of the light reflected from the mirror.

21. The polarizing assembly of claim 20, where the polarizer is a wire grid polarizer.

22. The polarizing assembly of claim 20, where the mirror is a metal mirror.

23. The polarizing assembly of claim 20, where the mirror is a dielectric mirror.

24. The polarizing assembly of claim 20, where the mirror and the half-wave plate are arranged to combine the reflected light with the light that passes through the polarizer.
